(19) United States
(12) Patent Application Publication
(10) Pub. No.: US 2018/0291890 A1
(43) Pub. Date: Oct. 11, 2018

(54) INTEGRATED MUFFLER ASSEMBLY

(71) Applicant: GARDNER DENVER THOMAS, INC., Sheboygan, WI (US)

(72) Inventor: Robert Joseph Suppiger, Grafton, WI (US)

(21) Appl. No.: 15/481,245

(22) Filed: Apr. 6, 2017

(51) Int. Cl. F04B 53/00; F04B 27/00; F04B 35/04; F04B 39/12; F04B 53/14; B01D 53/047

(52) U.S. Cl. CPC F04B 53/001; F04B 27/005; F04B 35/04; F04B 39/125; B01D 2259/40013; B01D 53/047; B01D 2256/12; B01D 2257/102; F04B 53/14

(57) ABSTRACT

A head assembly for a multi-cylinder compressor or pump having a first cylinder and a second cylinder includes a valve plate that has a first cylinder portion and a second cylinder portion. The valve plate further includes a valve plate face with a first aperture extending through the first cylinder portion and a second aperture extending through the second cylinder portion. The head assembly also includes a head cover having a head cover face, in which the head cover is operatively couplable to the valve plate. The head assembly further includes a first chamber formed by the valve plate cooperating with the head cover. The first chamber extends between and encloses the first and second apertures. The head assembly further includes a second chamber formed by the valve plate cooperating with the head cover. The second chamber is in fluid communication with the first chamber.

### FIELD OF INVENTION

The present disclosure relates to compressors and pumps and, more particularly, to an improved head assembly for a compressor or pump.

### SUMMARY

In one embodiment a multi-cylinder compressor or pump is provided, including a first cylinder housing having a first bore, a second cylinder housing having a second bore, a motor having a drive shaft, and a first piston coupled to the drive shaft and received in the first bore and a second piston coupled to the drive shaft and received in the second bore. The multi-cylinder compressor or pump further includes a valve plate having a first cylinder portion and a second cylinder portion. The valve plate further has a valve plate face with a first aperture extending through the first cylinder portion and a second aperture extending through the second cylinder portion. The first cylinder portion of the valve plate is coupled to the first cylinder housing and the second cylinder portion of the valve plate is coupled to the second cylinder housing such that the first aperture is in fluid communication with the first bore and the second aperture is in fluid communication with the second bore. The multi-cylinder compressor or pump further includes a head cover having a head cover face. The head cover is operatively coupled to the valve plate. The multi-cylinder compressor or pump further includes a first chamber formed by the valve plate cooperating with the head cover. The first chamber extending between and enclosing the first and second aperture. The multi-cylinder compressor or pump further includes a second chamber formed by the valve plate cooperating with the head cover. The second chamber is in fluid communication with the first chamber.

In one embodiment a head assembly for a multi-cylinder compressor or pump having first and second cylinders is provided, including a valve plate having a first cylinder portion and a second cylinder portion. The valve plate further including a valve plate face with a first aperture extending through the first cylinder portion and a second aperture extending through the second cylinder portion. The head assembly further includes a head cover having a head cover face. The head cover being operatively couplable to the valve plate. The head assembly further including a first chamber formed by the valve plate cooperating with the head cover, in which the first chamber extends between and encloses the first and second apertures. The head assembly further includes a second chamber formed by the valve plate cooperating with the head cover, in which the second chamber is in fluid communication with the first chamber.

In one embodiment a multi-cylinder compressor or pump is provided, including a first cylinder housing defining a first bore and a second cylinder housing defining a second bore. The multi-cylinder compressor or pump further includes a head assembly including a valve plate and a head cover, in which the valve plate cooperates with the head cover to form a first chamber, a second chamber, and a third chamber. The first chamber along with the second chamber surround a perimeter of the third chamber.

Other features and aspects of the disclosure will become apparent by consideration of the following detailed description and accompanying drawings.

### BRIEF DESCRIPTION OF THE DRAWINGS

FIG. 1 is a perspective view of a compressor.

FIG. 2 is a cross-sectional view of the compressor of FIG. 1 taken along line 2-2.

FIG. 3 is a partially exploded view of the compressor of FIG. 1.

FIG. 4 is an exploded view of a head assembly of the compressor of FIG. 1.

FIG. 5 is a top view of a valve plate of the head assembly of FIG. 4.

FIG. 6 is a bottom view of a head cover of the head assembly of FIG. 4.

FIG. 7 is an enlarged cross-sectional view of the compressor of FIG. 1 taken along line 7-7.

FIG. 8 is an enlarged cross-sectional view of the compressor of FIG. 1 taken along line 8-8.

FIG. 9 is an enlarged cross-sectional view of the compressor of FIG. 1 taken along line 9-9.

FIG. 10 is a partially exploded view of another head assembly.

FIG. 11 is a top view of a valve plate of the head assembly of FIG. 10.

FIG. 12 is a bottom view of a head cover of the head assembly of FIG. 10.

FIG. 13 is a cross-sectional perspective view of the head assembly of FIG. 10.

FIG. 14 is another cross-sectional perspective view of the head assembly of FIG. 10.

FIG. 15 is a partially exploded view of another head assembly.

FIG. 16 is a top view of a valve plate of the head assembly of FIG. 15.

FIG. 17 is a bottom view of a head cover of the head assembly of FIG. 15.

FIG. 18 is a cross-sectional perspective view of the head cover of FIG. 22 taken along line 18-18.

FIG. 19 is a cross-sectional perspective view of the head cover of FIG. 15 taken along line 19-19.

FIG. 20 is a cross-sectional perspective view of the head cover of FIG. 15 taken along line 20-20.

FIG. 21 is a perspective view of another compressor.

FIG. 22 is a cross-sectional view of the compressor of FIG. 21 taken along line 22-22.

FIG. 23 is a partially exploded view of the compressor of FIG. 21.

FIG. 24 is an exploded view of a head assembly of the compressor of FIG. 21.

FIG. 25 is another view of the head assembly of FIG. 24.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

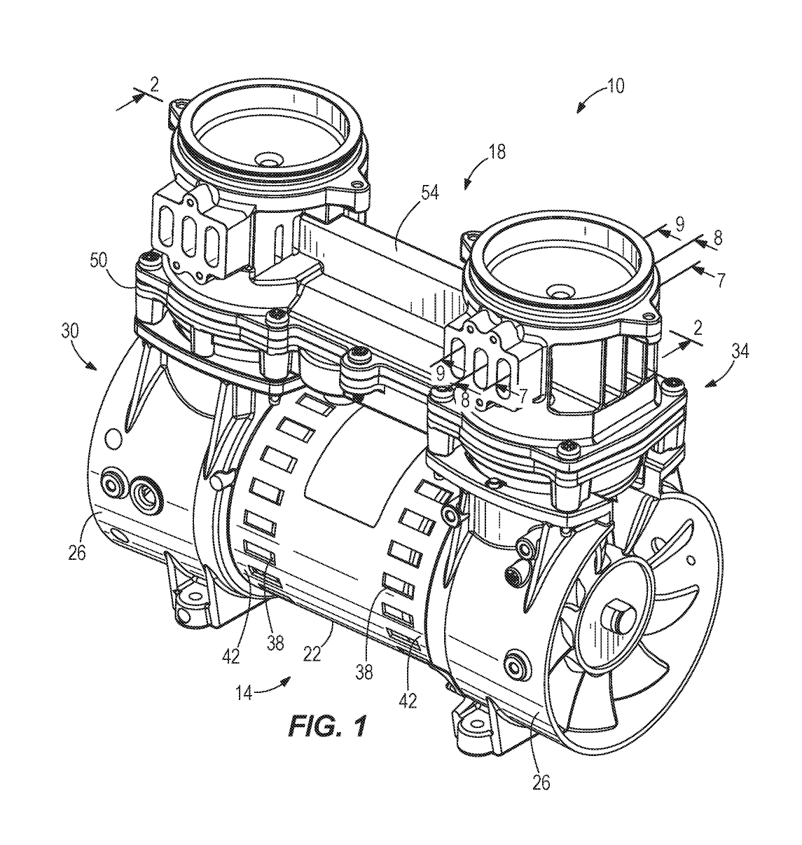

FIG. 1 illustrates a multi-cylinder air compressor 10 for oxygen concentration including a housing assembly 14 and a head assembly 18. The housing assembly 14 includes a circular cylindrical thin wall spacer or motor sleeve 22 between end housings 26 that correspond to first and second cylinders 30, 34 of the compressor 10. The end housings 26 are preferably formed of a cast material, such as aluminum. The motor sleeve 22 has perforations 38 adjacent opposing ends 42 of the motor sleeve 22 for purposes of air flow. The head assembly 18 includes a valve plate 50 and a head manifold or head cover 54 and may further include a pair of pressure swing absorption oxygen concentrators (not shown) mounted on the head cover 54 for separating oxygen and nitrogen from compressed air.

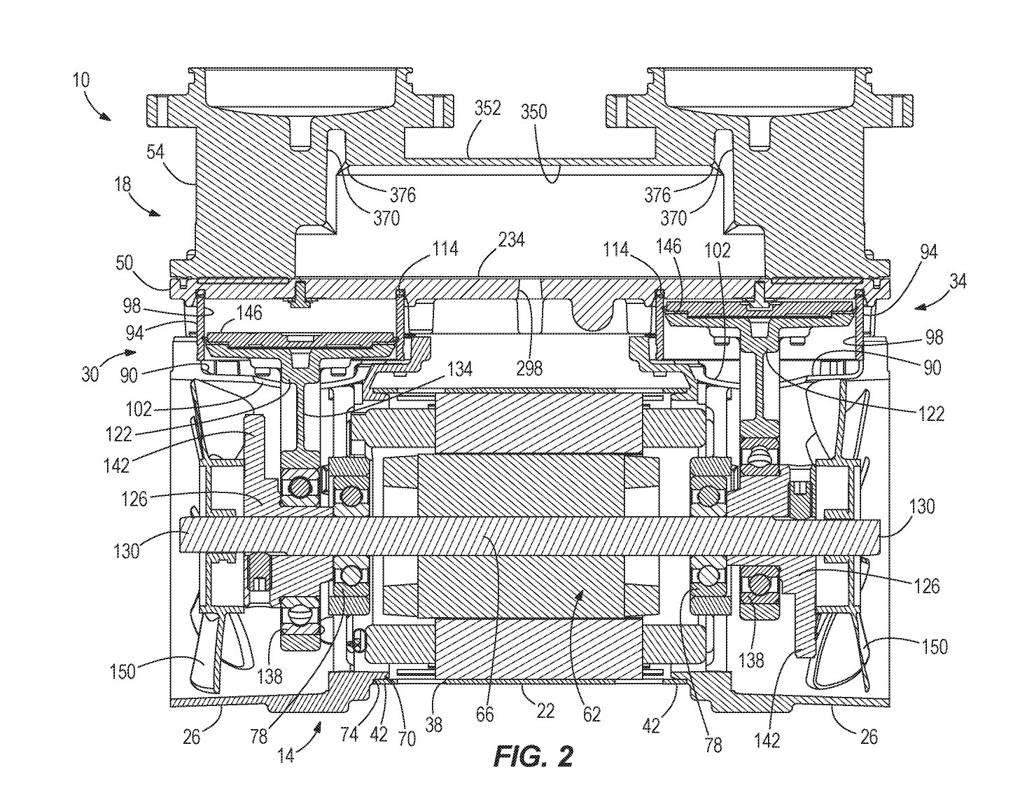

With additional reference to FIG. 2, the compressor 10 further includes an electric motor 62 having a through drive shaft 66 encircled by the motor sleeve 22. Each of the end housings 26 includes a circumferential flange 70 having a relief 74 so as to receive the opposing ends 42 of the motor sleeve 22 to join the end housings 26 to the motor sleeve 22. Bearings 78 support the drive shaft 66 of the motor 62.

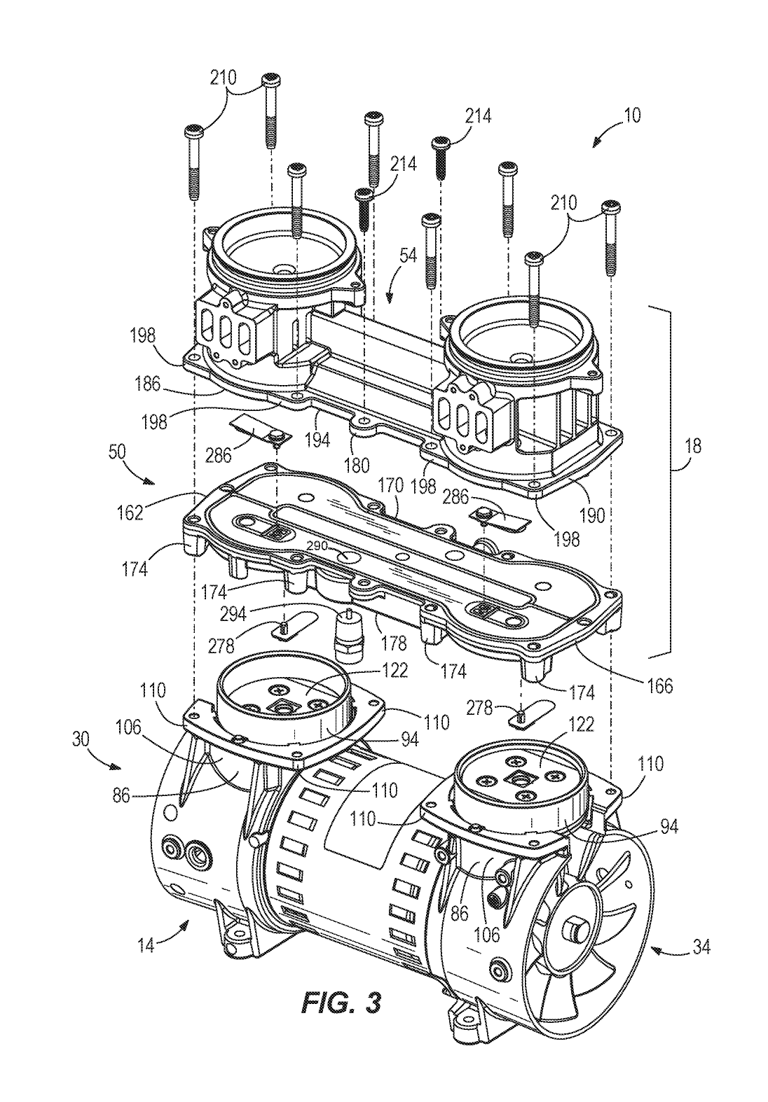

With continued reference to FIGS. 2 and 3, each of the end housings 26 includes a cylinder extension 86 for each of the cylinders 30, 34 of the compressor 10. The cylinder extension 86 has a support floor 90 that supports a cylinder sleeve 94 defining a bore 98. The support floor 90 has an opening 102. The cylinder extension 86 has sidewalls 106 that terminate in housing bosses 110 to support and mount the valve plate 50 (FIG. 3). An O-ring 114 is mounted to the valve plate 50 between the valve plate 50 and a top edge of the cylinder sleeve 94 to seal the top edge of the bore 98.

The compressor 10 further includes a piston 122 and an eccentric 126 associated with each of the cylinders 30, 34 and mounted adjacent each opposing distal end 130 of the drive shaft 66. More specifically, the rod 134 of each piston 122 is mounted on a bearing 138 supported by the eccentric 126 such that the axis of the eccentric 126 is offset from that of the drive shaft 66. The eccentric 126 includes a counterweight 142. A piston 122 is positioned within each bore 98 of the cylinder sleeve 94 such that the rod 134 of the piston 122 extends through the opening 102 in the support floor 90. The piston 122 includes a peripheral seal 146 that seals with the bore 98 of the cylinder sleeve 94.

A fan 150 is mounted on each of the distal ends of the drive shaft 66 within the hollow interior of the end housings 26 in order to draw air into the end housings 26 as the motor 62 rotates to cool the motor 62. Air may also be forced through the opening 102 in the support floor 90 to cool the cylinder sleeve 94 and the piston 122.

With further reference to FIG. 3, the valve plate 50 of the head assembly 18 includes first and second cylinder portions 162, 166 corresponding to the first and second cylinders 30, 34, and a middle portion 170 connecting the first and second cylinder portions 162, 166. Each of the cylinders portions 162, 166 has support bosses 174 corresponding with and supported by the housing bosses 110 on the end housings 26.

The head cover 54 includes first and second cylinder portions 186, 190 corresponding to the first and second cylinders 30, 34, and a middle portion 194 therebetween. Each of the cylinder portions 186, 190 includes mounting bosses 198 supported by the support bosses 174 of the valve plate 50. First fasteners 210 are threaded through the mounting bosses 198 of the head cover 54, the support bosses 174 of the valve plate 50, and into the housing bosses 110 to couple the head cover 54, the valve plate 50, and the housing assembly 14. Second fasteners 214 are threaded through middle bosses 178 on the middle portion 170 of the valve plate 50 and corresponding middle bosses 180 on the middle portion 194 of the head cover 54 to provide additional clamping force between the head cover 54 and the valve plate 50 to prevent gas leakage around the location at which the middle portions 170, 194 of the head cover 54 and the valve plate 50 meet when coupled together.

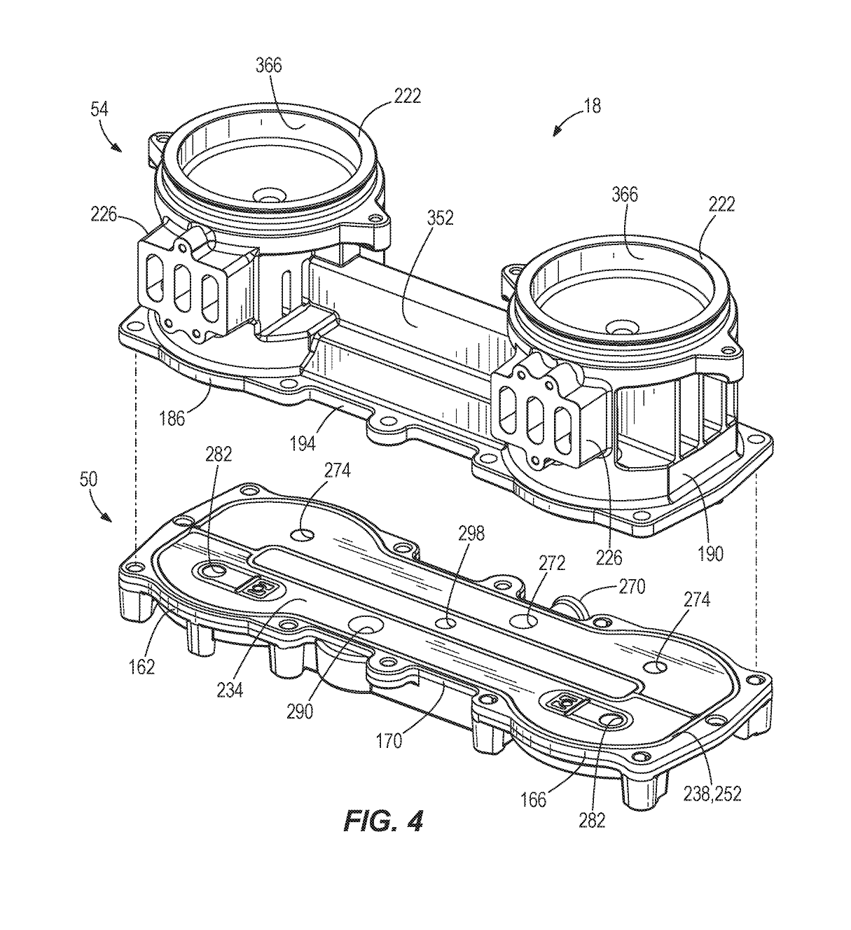

With reference to FIG. 4, each of the first and second cylinder portions 186, 190 of the head cover 54 includes a sieve bed seat 222 for mounting each of the pressure swing absorption oxygen concentrators (not shown) and an oxygenator manifold 226. A solenoid valve (not shown) is mounted on each of the oxygenator manifold 226 for controlling air flow to the oxygen concentrators and purged nitrogen flow out of the compressor 10.

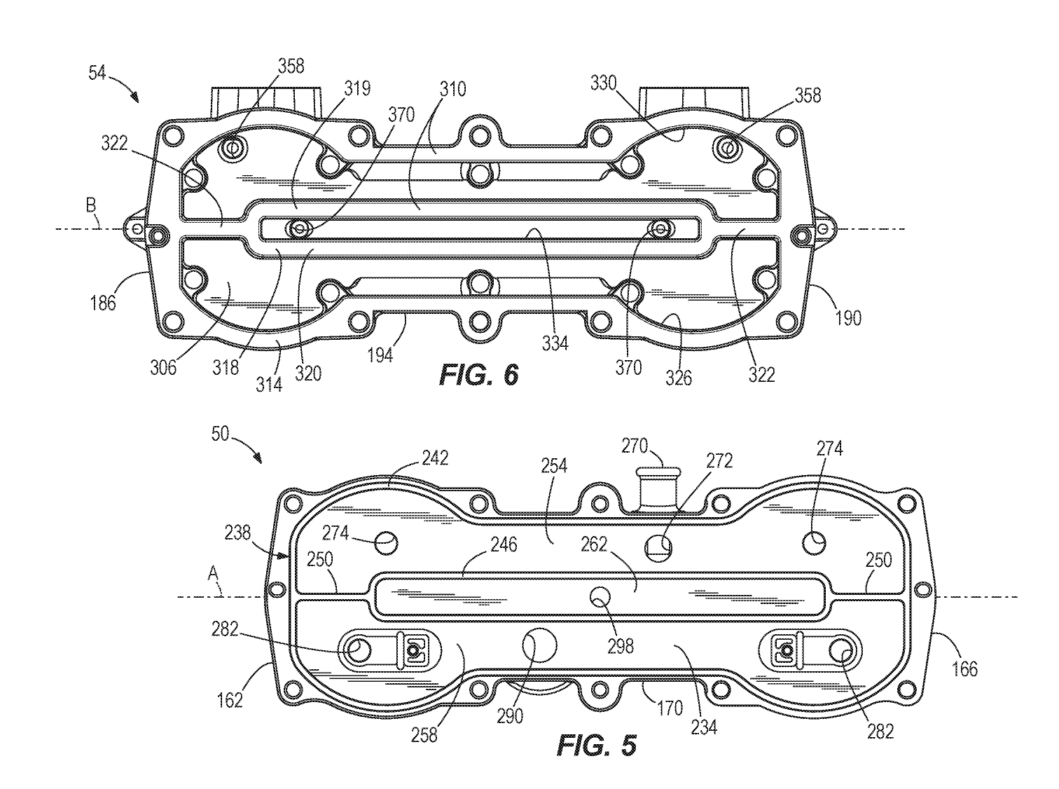

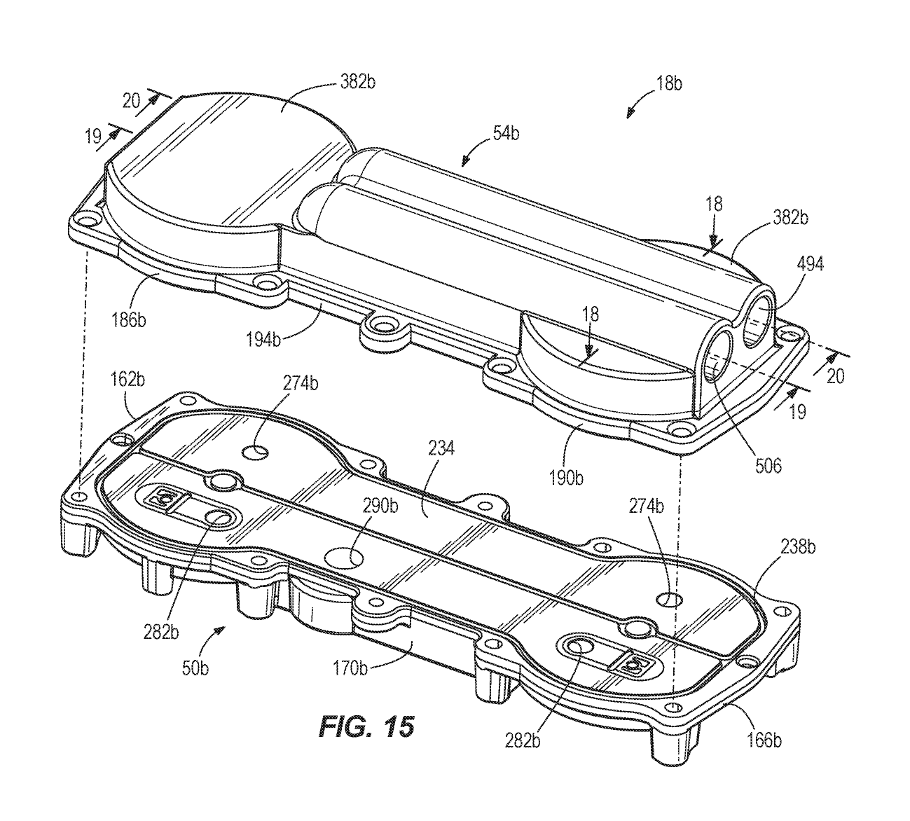

With reference to FIGS. 4-5, the valve plate 50 includes a valve plate face or top surface 234 that extends across the first and second cylinder portions 162, 166 and the middle portion 170. The top surface 234 defines grooves 238 comprising an outer groove 242 that extends around the perimeter of the valve plate 50, an inner groove 246 that extends on the top surface 234 within a perimeter of and concentric with the outer groove 242, and connecting grooves 250 that connect the inner grooves 246 and the outer grooves 242 within the first and second cylinder portions 162, 166. The grooves 238 support a circuitous gasket 252 made of rubber or another suitable sealing material and define an intake section 254, an exhaust section 258, and a purge or muffler section 262. The intake section 254 and the exhaust section 258 are defined by the grooves 238 so as to be continuous between the first cylinder portion 162, the middle portion 170, and the second cylinder portion 166. The inner groove 246 defines the muffler section 262 so as to extend across the middle portion 170, such that the inner groove 246 and the connecting grooves 250 bisect the outer groove 242 along a horizontal centerline A extending longitudinally between the first and second cylinder portions 162, 166. Accordingly, the intake section 254 and the exhaust section 258 are on opposite sides of the muffler section 262 and the connecting grooves 250. In alternative embodiments, a single groove may bisect the outer groove 242 along the horizontal centerline A so as to only define the intake section 254 and the exhaust section 258, in lieu of a muffler section 262 (i.e., similar to center groove 478 of FIGS. 15-20).

The valve plate 50 includes an intake port 270 that communicates with the intake section 254 at an intake opening 272. The valve plate 50 further includes a bore inlet aperture 274 defined in and extending through each of the first and second cylinder portions 162, 166 corresponding to each of the cylinders 30, 34 within the intake section 254. Each of the bore inlet apertures 274 has a corresponding bore inlet flapper valve 278 to allow intake air to enter the cylinder bores 98 from the intake section 254, but not vice versa. The valve plate 50 further includes a bore outlet aperture 282 defined in and extending through each of the first and second cylinder portions 162, 166 corresponding to each of the cylinders 30, 34 within the exhaust section 258. Each of the bore outlet apertures 282 has a corresponding bore outlet flapper valve 286 to allow exhaust air to exit the cylinder bores 98, but not vice versa. The exhaust section 258 also has a safety valve support recess 290 that receives a pressure relief or safety valve 294 (FIG. 3). The muffler section 262 includes an exhaust port 298, located centrally within the muffler section 262 through the top surface 234 of the valve plate 50.

With reference to FIG. 6, the head cover 54 includes a head cover face or inner bottom surface 306 and a series of continuous dividers or walls 310 that correspond to the grooves 238 of the valve plate 50 and extend generally perpendicularly downward from the bottom surface 306 of the head cover 54. The series of walls 310 includes an outer wall 314 extending around the perimeter of the head cover 54, an inner wall 318 within the outer wall 314, and connecting walls 322 connecting the inner wall 318 and the outer wall 314 in the first and second cylinder portions 186, 190 of the head cover 54. The inner wall 318 includes first and second portions 319, 320. The series of walls 310 extend from the bottom surface 306 so as to form an intake channel 326, an exhaust channel 330, and a purge or muffler channel 334. Like the grooves 238 of the valve plate 50, the inner wall 318 defines the muffler channel 334, such that inner wall 318 and the connecting walls 322 divide the outer wall 314 along a horizontal centerline B extending longitudinally between the first and second cylinder portions 186, 190. Accordingly, the intake channel 326 and the exhaust channel 330 are located on opposite sides of the muffler channel 334 and the connecting walls 322. In alternative embodiments, the connecting walls 322 may extend along the horizontal centerline B and meet to form a single wall that bisects the outer wall 314 so as to define the intake channel 326 and the exhaust channel 330, in lieu of a muffler channel 334 (i.e., similar to center wall 482 of FIGS. 15-20).

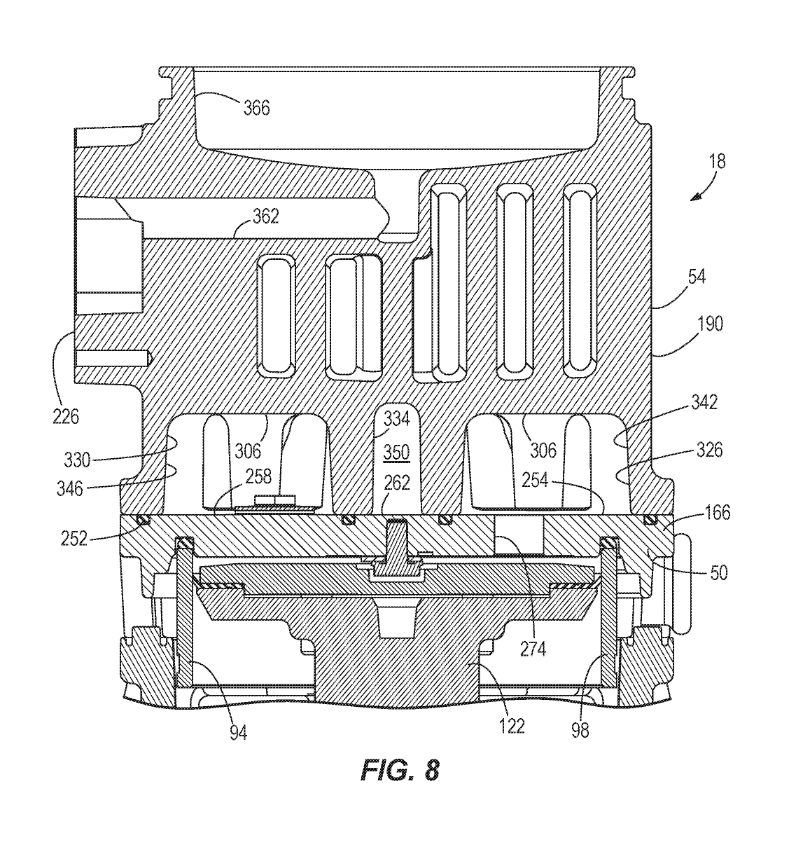

The series of walls 310 cooperate with the grooves 238 such that when the valve plate 50 and the head cover 54 are coupled together, the intake section 254, the exhaust section 258, and the muffler section 262 are aligned with the intake channel 326, the exhaust channel 330, and the muffler channel 334, respectively, to form an intake chamber 342, an exhaust chamber 346, and an integrated muffler chamber 350, illustrated cross-sectionally in FIG. 8. A bottom edge of the series of walls 310 compresses the circuitous gasket 252 within the grooves 238 to seal the intake chamber 342, the exhaust chamber 346, and the muffler chamber 350 to inhibit leaking between the top surface 234 of the valve plate 50 and the bottom edge of the walls 310 of the head cover 54. The intake chamber 342 forms a fluid conduit extending between and enclosing the intake opening 272 and the bore inlet apertures 274. The exhaust chamber 346 forms a fluid conduit extending between and enclosing the bore outlet apertures 282. In the illustrated embodiment, the muffler chamber 350 is positioned between the intake chamber 342 and the exhaust chamber 346 such that the intake chamber 342 and the exhaust chamber 346 surround the muffler chamber 350 around a perimeter of the muffler chamber 350 defined by the inner wall 318. Accordingly, the first portion 319 of the inner wall 318 partially defines and is shared between the muffler chamber 350 and the exhaust chamber 346, and the second portion 320 of the inner wall 318 partially defines and is shared between the muffler chamber 350 and the intake chamber 342.

Although in the illustrated embodiment the grooves 238 are defined in the top surface 234 of the valve plate 50 and the walls 310 extend down from the bottom surface 306 of the head cover 54, in alternative embodiments the walls 310 may extend up from the valve plate 50 and the grooves 238 may be defined by the head cover 54. In other words, the valve plate 50 may be a “bath tub” type design, and the head cover 54 may be a substantially flat cover. In such embodiments, the walls 310 are integrally formed as a single piece with one of the valve plate 50 and the head cover 54. In yet other embodiments, the walls 310 may be a separate component fixedly coupled to one or both the valve plate 50 and the head cover 54. In such embodiments, both the valve plate 50 and the head cover 54 may be flat plate type designs or “bath tub” type designs or any combination thereof. In further embodiments, some of the walls 310 may extend from the head cover 54 and some of the walls 310 may extend from the valve plate 50. In additional embodiments, the walls 310 are not associated with grooves in the mating surface, but are configured to contact, with or without a gasket, the opposing previously described surfaces of the valve plate 50 or head cover 54. Further, although the intake port 270 and the exhaust port 298 are defined by the valve plate 50, in alternative embodiments, the intake port 270 and the exhaust port 298 may each be defined by the head cover 54.

In any of these possible combinations both the valve plate 50 and the head cover 54 may be formed from die-casting processes that do not require cores to define the chambers entirely within the head cover 54 or the valve plate 50 when cast. Accordingly, the head cover 54 may be made from plastic, in addition to aluminum and other suitable materials. In addition, each of the valve plate 50 and the head cover 54 may be integrally formed from a single piece.

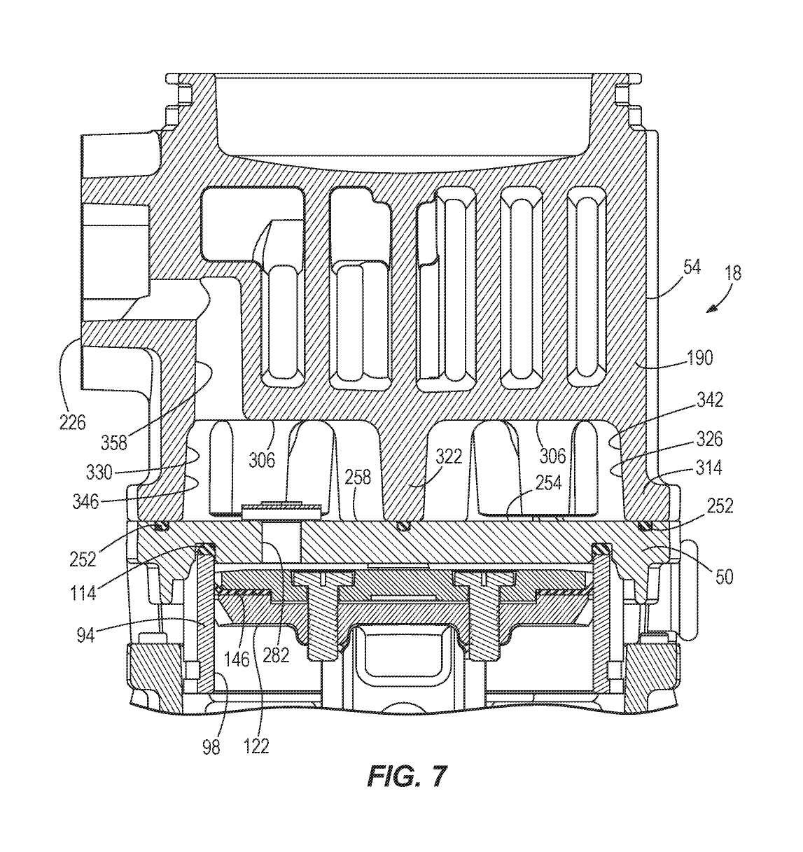

With continued reference to FIGS. 6 and 7, an exhaust outlet passage 358 is defined in the bottom surface 306 in each of the first and second cylinder portions 186, 190 of the head cover 54. Each of the exhaust outlet passages 358 extends from the exhaust chamber 346 to a corresponding one of the oxygenator manifolds 226, as shown in FIG. 7. As such, the exhaust outlet passages 358 are in fluid communication with the fluid conduit formed by the exhaust chamber 346.

With reference to FIG. 8, a sieve bed passage 362 is defined by the head cover 54 in each of the first and second cylinder portions 186, 190. The sieve bed passages 362 extends from the oxygenator manifold 226 to a sieve bed recess 366 defined by each of the first and second cylinder portions 186, 190 adjacent the sieve bed seat 222. The sieve bed recess 366 receives an absorbent bed (e.g., a zeolite bed).

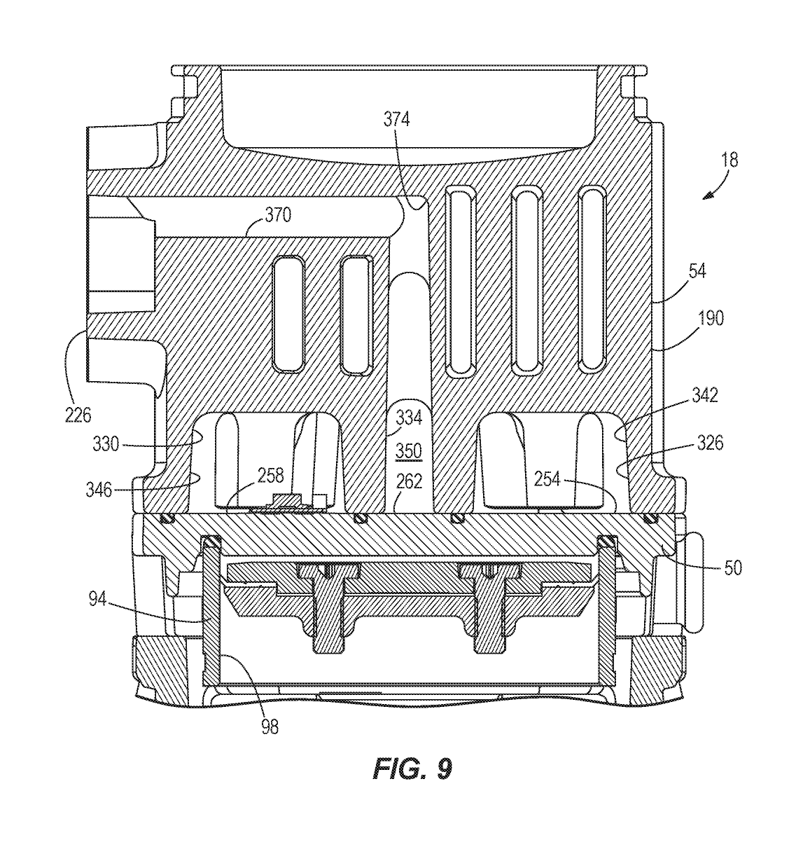

With reference to FIGS. 6 and 9, a muffler inlet passage 370 is defined in each of the first and second cylinder portions 186, 190 of the head cover 54. The muffler inlet passage 370 extends from the oxygenator manifold 226 to the muffler chamber 350, as best shown in FIG. 9. The muffler chamber 350 forms a fluid conduit between the muffler inlet passages 370 and the exhaust port 298.

Each of the muffler inlet passages 370 includes a bend 374 (FIG. 9). In the illustrated embodiment, the bend 374 in the muffler inlet passages 370 is approximately a right angle, but in some embodiments the bend 374 in the muffler inlet passages 370 may be between approximately 75 degrees and approximately 105 degrees. The muffler inlet passages 370 are also positioned at opposing ends of the muffler chamber 350, while the exhaust port 298 is positioned centrally on the muffler section 262 of the valve plate 50 within the muffler chamber 350. The muffler chamber 350 forms a bend portion 376 where air exits each of the muffler inlet passages 370 into the muffler chamber 350 (FIG. 2). In the illustrated embodiment, the bend portion 376 is a right angle bend, but in other embodiments may be between approximately 75 degrees and approximately 105 degrees.

The head cover 350 further comprises a muffler expanding portion 352 in the middle portion 194 of the head cover 54 that defines a volume, such that a larger volume is created in the muffler chamber 350 (FIG. 4). In some embodiments, a sound dampening medium may also at least partially line or be positioned within the muffler chamber 350. In some embodiments, the muffler chamber 350 may include a plurality of baffles extending from any of the walls defining the muffler chamber 350 of the head cover 54. In some embodiments, a filter medium may be positioned within the muffler chamber 350. In some embodiments, the muffler chamber 350 may be purposed for heat exchange and insulation, and as such may include insulation medium such as insulating foam. In alternative embodiments, the inner wall 318 of the muffler chamber 350 may extend between the outer wall 314 in the first and second cylinder portions 186, 190 along the horizontal center B. In other words, the connecting walls 322 may each be a double wall in communication with the muffler chamber 350 to lengthen the muffler chamber 350. In further alternative embodiments, the muffler chamber 350 may be entirely defined by either the valve plate 50 or the head cover 54 as shown in the embodiment of FIGS. 15-20. The muffler chamber 350 may also be partially formed by either the valve plate 50 or the head cover 54 and entirely formed when coupling a separate independent cover thereto instead of when coupling the valve plate 50 and the head cover 54 together. In any such embodiment, one or more muffler chambers may be arranged to be directly downstream and/or upstream of the intake port and/or exhaust port, respectively.

Referring back to FIGS. 4 and 7-9, the solenoid valve is configured to control flow of the exhaust air from the exhaust chamber 346 to the sieve bed, and expelled or purged nitrogen from the sieve bed to the muffler chamber 350. In particular, when the solenoid valve is in a first position, the muffler inlet passage 370 is blocked in the oxygenator manifold 226, so that only the exhaust outlet passage 358 and the sieve bed passage 362 are in fluid communication. When the solenoid valve is in a second position, the exhaust outlet passage 358 is blocked in the oxygenator manifold 226, so that the sieve bed passage 362 and the muffler inlet passage 370 are in fluid communication through the oxygenator manifold 226.

The compressor 10 is assembled by positioning the motor 62 and the drive shaft 66 axially within the motor sleeve 22. The end housings 26 are coupled to each end of the motor sleeve 22. The eccentrics 126, pistons 122 and fans 150 are connected to the opposing ends of the drive shaft 66. The cylinder sleeve 94 is seated on the support floor 90 of each of the cylinder extensions 86. The valve plate 50 is then positioned such that the first cylinder portion 162 is mounted over the first cylinder 30, and the second cylinder portion 166 is mounted over the second cylinder 34, with the middle portion 170 extending therebetween. The O-rings 114 are positioned between the top edge of each of the cylinder sleeves 94 and the valve plate 50. The circuitous gasket 252 is fitted into the grooves 238 within the top surface 234 of the valve plate 50. The head cover 54 is mounted on the valve plate 50 so that each of the first cylinder portion 186, the second cylinder portion 190, and the middle portion 194 of the head cover 54 align with the first cylinder portion 162 the second cylinder portion 166 and the middle portion 170 of the valve plate 50. The walls 310 defining the intake channel 326, the exhaust channel 330, and muffler channel 334 of the head cover 54 are aligned on the circuitous gasket 252 with the corresponding intake section 254, the exhaust section 258, and muffler section 262 of the valve plate 50 so as to form the respective intake chamber 342, the exhaust chamber 346, and the muffler chamber 350. The first fasteners 210 are then threaded through the aligned bosses 198, 174, 110 of the head cover 54, valve plate 50, and end housings 26 to couple the head cover 54, valve plate 50, and end housings 26 together. The second fasteners 214 are also threaded through the aligned middle bosses 178, 180 of the valve plate 50 and the head cover 54. The walls 310 of the head cover 54 compress the circuitous gasket 252 within the grooves 238 of the valve plate 50 as the head cover 54 is coupled to the valve plate 50, thereby forming and sealing the intake chamber 342, the exhaust chamber 346, and the muffler chamber 350.

In operation, the motor 62 rotationally drives the drive shaft 66, causing the pistons 122 to reciprocate within the bores 98 of each of the cylinders 30, 34. During a downstroke of each of the pistons 122, air is drawn into the intake chamber 342 through the intake port 270 from the surrounding environment. The air is then alternatively drawn into the bore 98 of each of the first and second cylinders 30, 34 through the corresponding bore inlet aperture 274 depending on the direction of travel of the respective piston 122, offset by virtue of the pair of eccentrics 126. The inlet flapper valves 278 permit air to enter the bores 98 through the bore inlet apertures 274, but prevent air from reentering the intake chamber 342. The air is thereafter compressed by the upstroke of the piston 122 within the bore 98 and forced out the bore outlet aperture 282 through the outlet flapper valve 286 at an increased pressure. The outlet flapper valve 286 prevents the compressed air from reentering the bore 98. The compressed air leaves the bore outlet aperture 282 of each of the first and second cylinders 30, 34 and enters the exhaust chamber 346. The compressed air recombines (the extent of which depends on the rotational speed of the drive shaft 66) after exiting the bores 98 of each of the cylinders 30, 34 within the exhaust chamber 346 and flows from the exhaust chamber 346 to the oxygenator manifold 226 of each of the cylinders 30, 34 through the each of the exhaust outlet passages 358 (FIG. 7).

When the solenoid valve is in the first position, the pressurized air flows through the sieve bed passage 362 into the sieve bed of the oxygen concentrator of each of the cylinder portions 186, 190. The pressurized air then undergoes pressure swing absorption, such that oxygen and nitrogen in the air are substantially separated. The solenoid valve is periodically switched to the second position to permit purged nitrogen to flow from the sieve bed back through the sieve bed passage 362 to the oxygenator manifold 226. Purged nitrogen then flows from the manifold 226 through the muffler inlet passage 370 of each of the first and second cylinder portions 186, 190 into the muffler chamber 350. The bend 374 in the muffler inlet passage 370 and the bend portion 376 within the muffler chamber 350 provide for changes in direction and a longer circuitous path for exhaust gas to travel, thereby facilitating sound dampening. The expanded volume of the muffler chamber 350 provides for an expansion space for exhaust gas (e.g., nitrogen) that leaves the muffler inlet passages 370, thereby facilitating sound dampening of the exhaust gas through expansion into the muffler chamber 350. The position of the muffler chamber 350 as integrated into the head assembly 18 and positioned between the intake chamber 342 and the exhaust chamber 346 provides further sound dampening. The purged nitrogen may also pass through a sound dampening medium, or alternatively around baffles, positioned within or lining the muffler chamber 350 to provide for additional sound reduction and dampening. The baffles provide a more circuitous path for exhaust gas to travel. The purged nitrogen combines within the muffler chamber 350 and is exhausted out of the exhaust port 298 in the center of the valve plate 50 within the muffler chamber 350.

The purged nitrogen in the muffler chamber 350 also reduces heat transfer between flow in the intake chamber 342 and flow in the exhaust chamber 346, by providing an insulated layer therebetween. Purged nitrogen in the muffler chamber 350, which is at a lower temperature than compressed air in the exhaust chamber 346, generates an insulative effect between the exhaust chamber 346 and the intake chamber 342 to impede air in the exhaust chamber 346, which is above the temperature of air in the intake chamber 342, from raising the temperature of air in the intake chamber 342. Specifically, as shown in FIG. 6, the first portion 319 of the inner wall 318 partially defines the exhaust chamber 346 and the second portion 320 of the inner wall 318 partially defines the intake chamber 342, thereby separating the exhaust chamber 346 and the intake chamber 342 by a width of the muffler chamber 350. This configuration further permits the muffler chamber 350 to act as a heat exchanger, providing insulation between air in the exhaust chamber 346 and the intake chamber 342. In particular, it is desirable to impede hot pressurized exhaust air from raising the temperature of intake air, which is typically at ambient temperature, to improve efficiency. The gas passing through the muffler chamber 350 is cooled and absorbs heat from the exhaust air in the exhaust chamber 346, thereby inhibiting the exhaust air from raising the temperature of the intake air. As previously mentioned, the muffler chamber 350 may include insulation material specifically for reducing heat transfer between the intake chamber 342 and the exhaust chamber 346.

Although in the illustrated embodiment the compressor 10 includes pressure swing absorption oxygen concentrators configured for oxygen concentration, in alternative embodiments, the compressor 10 and the head assembly 18 may be configured simply for gas (e.g., air) compression. In such an embodiment, the head cover 54 does not include the solenoid valves or the sieve bed seats 222 for mounting the oxygen concentrators. Accordingly, each of the first and second cylinder portions 186, 190 of the head cover 54 defines a passage that fluidly communicates the exhaust chamber 346 and the muffler chamber 350. As such, in operation, compressed air flows through the passages from the exhaust chamber 346 to the muffler chamber 350. The compressed air then exits the muffler chamber 350 through the exhaust port 298. Alternatively, the inner wall 318 may include an opening or plurality of openings that communicate the exhaust chamber 346 directly with the muffler chamber 350, in lieu of the muffler inlet passage 370 and the exhaust outlet passages 358. A series of baffles may be disposed within either or both of the exhaust chamber 346 and the muffler chamber 350 so as to provide a tortuous or circuitous path for the compressed air to flow before exiting through the exhaust port 298. The exhaust chamber 346 and muffler chamber 350 may optionally include insulative, sound-dampening, or filter materials.

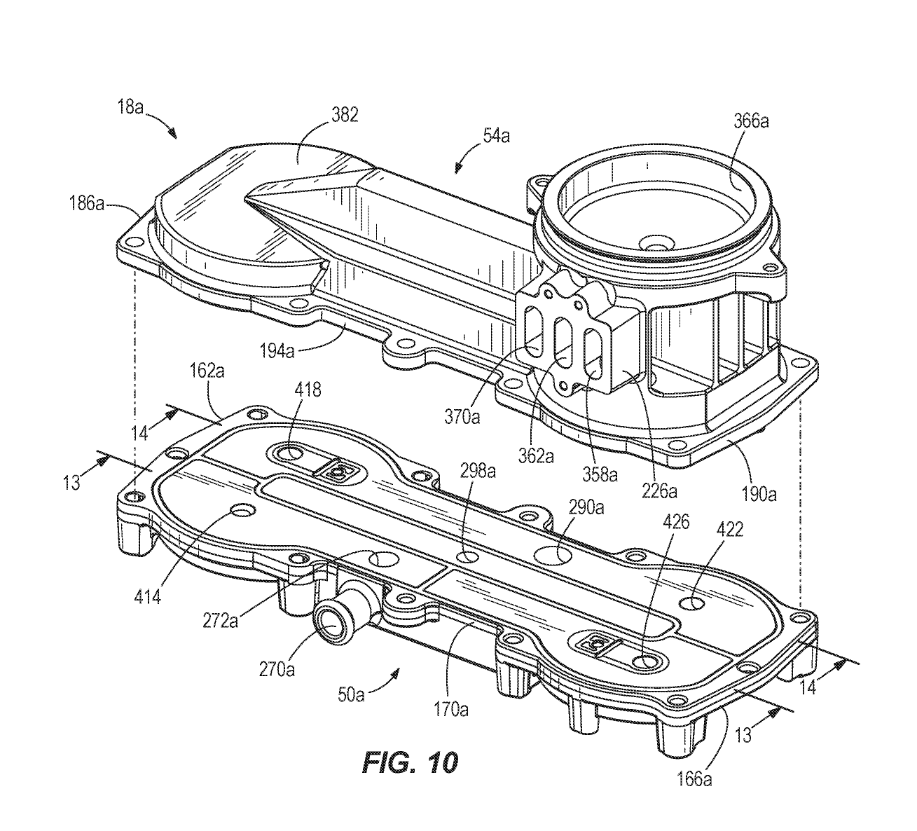

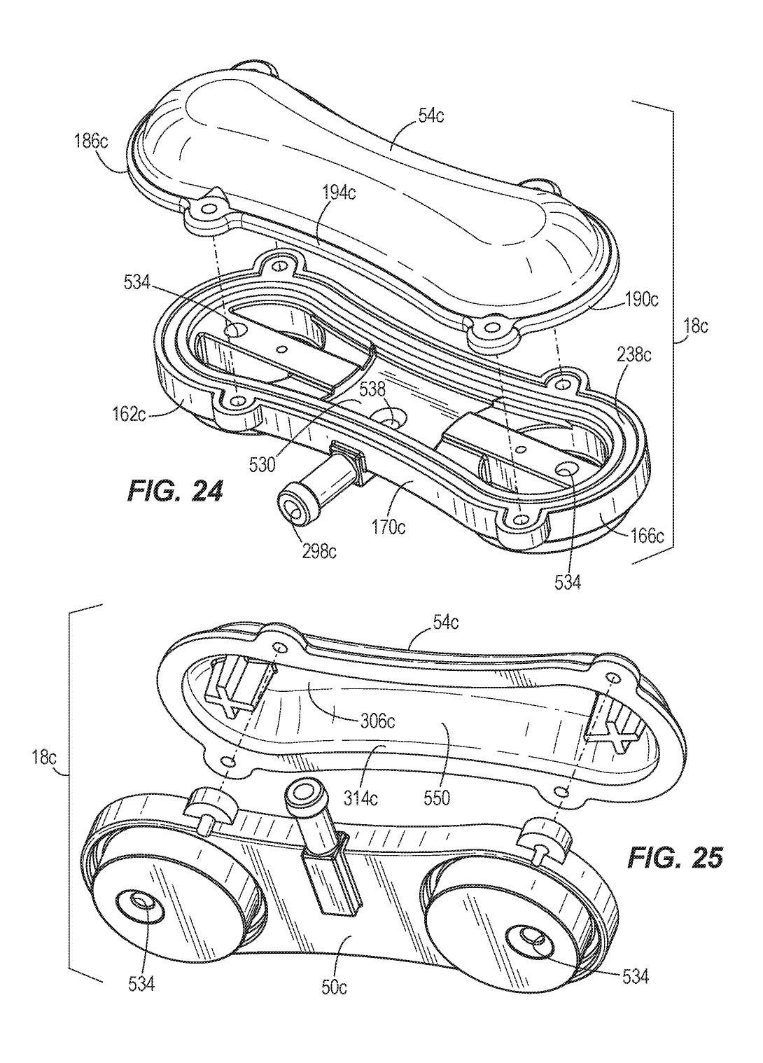

Although in the illustrated embodiment the head assembly 18 is configured for single stage parallel flow, in alternative embodiments, the grooves 238 and the corresponding walls 310 may be configured for any type of flow configuration (e.g., a multi-stage series flow embodiment or a single exhaust chamber embodiment, as illustrated in FIGS. 10-14 and FIGS. 21-25 respectively, and as described below).

In an alternative embodiment, the head assembly 18 may be reconfigured such that the exhaust port 298 is an intake port that leads directly into a muffler chamber like the muffler chamber 350, such that flow through the compressor 10 is essentially reversed. In such an embodiment, air is drawn through the intake port (i.e., exhaust port 298) into the muffler chamber 350. The air travels through the muffler chamber 350 to provide sound dampening using the various methods described above. The muffler chamber 350 is in direct communication with the exhaust chamber 346, whereby the flapper valves 286 are reconfigured to allow air to enter the bores 98 from the exhaust chamber 346 via the apertures 282. In addition, the flapper valves 278 are reconfigured to allow compressed air to enter the intake chamber 342 through the apertures 274. The compressed air may flow through the intake opening 272 out the intake port 270.

FIGS. 10-14 illustrate a head assembly 18a in accordance with a multi-stage, series flow embodiment that may be used in place of the head assembly 18 on the compressor 10 of FIGS. 1-9. Thus, the housing assembly 14 will not be described again in detail, and only differences in the structure and manner of operation of the compressor 10 when using the head assembly 18a of FIGS. 10-14 will be described below. Like components and features to the head assembly 18 of FIGS. 1-9 are identified with like reference numerals plus the letter “a” and will not be described again in detail.

With reference to FIG. 10, only the second cylinder portion 190a of the head cover 54a includes the sieve bed seat 222a and the oxygenator manifold 226a, while the first cylinder portion 186a of the head cover 54a simply includes a cylinder cover 382.

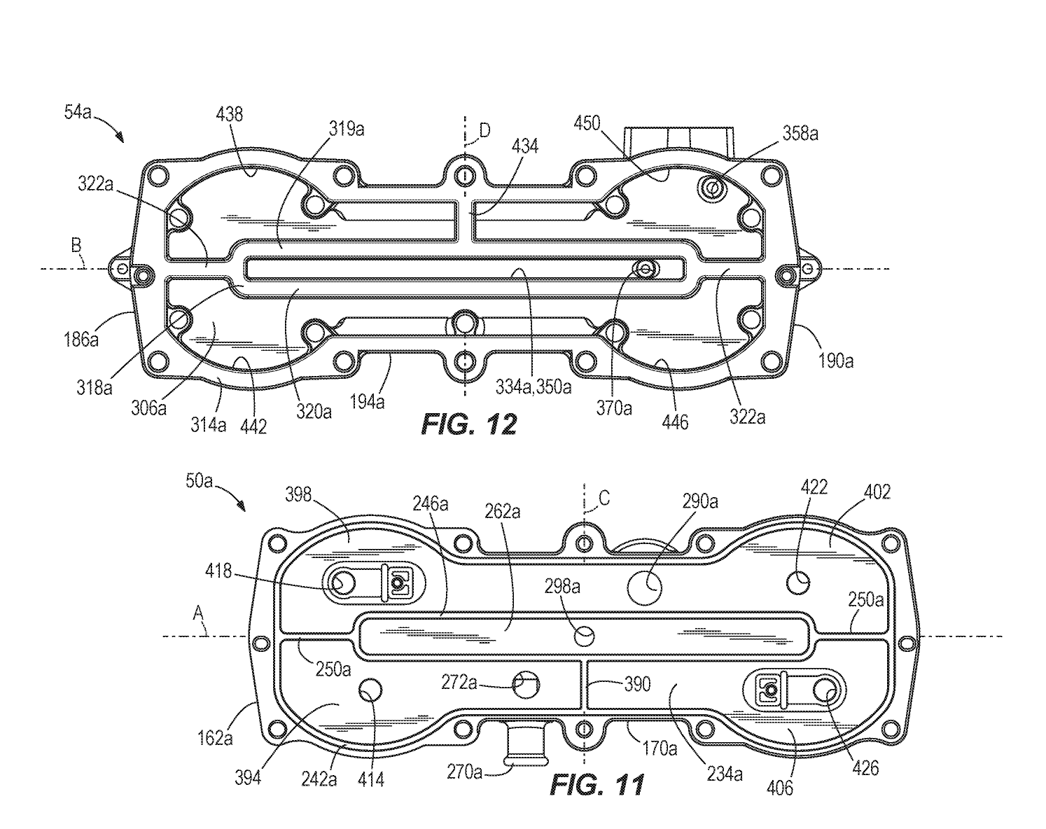

With reference to FIGS. 10-11, the grooves 238a in the top surface 234a of the valve plate 50a comprise an outer groove 242a extending around the perimeter of the valve plate 50a, an inner groove 246a within a perimeter of the outer groove 242a, and first connecting grooves 250a connecting the inner grooves 246a and the outer grooves 242a within the first and second cylinder portions 162a, 166a. The grooves 238a further include a second connecting groove 390 extending between the outer groove 242a and the inner groove 246a along a vertical centerline C of the middle portion 170a of the valve plate 50a. The grooves 238a define a first stage intake section 394, a first stage exhaust section 398, a second stage intake section 402, a second stage exhaust section 406, and the muffler section 262a. The first stage intake section 394 is defined within the first cylinder portion 162a by the outer groove 242a, the inner groove 246a, one of the first connecting grooves 250a and the second connecting groove 390. The first stage exhaust section 398 and the second stage intake section 402 are continuous with one another and are defined within the first and second cylinder portions 162a, 166a and the middle portion 170a by the outer groove 242a, the inner groove 246a, and the first connecting grooves 250a so as to form an intermediate section. The second stage exhaust section 406 is defined within the second cylinder portion 162a by the outer groove 242a, the inner groove 246a, one of the first connecting grooves 250a, and the second connecting groove 390. In alternative embodiments, a single groove may bisect the outer groove 242a along the horizontal centerline A so as to only define the first stage intake section 394, the first stage exhaust section 398, the second stage intake section 402, and the second stage exhaust section 406, in lieu of a muffler section 262 (i.e., similar to center groove 478 of FIGS. 15-20).

The intake port 270a communicates with an intake opening 272a defined in the first stage intake section 394 of the valve plate 50a. A first bore inlet aperture 414 and a first bore outlet aperture 418 are defined in the first cylinder portion 162a so as to extend through the valve plate 50a for fluid communication with the bore 98a of the first cylinder 30a, each having a corresponding flapper valve (not shown). The first bore inlet aperture 414 is located in the first stage intake section 394 and the first bore outlet aperture 418 is located in the first stage exhaust section 398. A second bore inlet aperture 422 and a second bore outlet aperture 426 are defined in the second cylinder portion 166a so as to extend through the valve plate 50a for fluid communication with the bore 98a of the second cylinder 34a, each having a corresponding flapper valve (not shown). The second bore inlet aperture 422 is located in the second stage intake section 402 and the second bore outlet aperture 426 is located in the second stage exhaust section 406. The safety valve support recess 290a is defined in the intermediate section and receives a safety valve (like safety valve 294 shown in FIG. 3). Although not illustrated, the second stage exhaust section 406 may also include a recess for supporting an additional safety valve.

With reference to FIG. 12, the walls 310a of the head cover 54a includes an outer wall 314a extending around the perimeter of the head cover 54a, an inner wall 318a within a perimeter of the outer wall 314a, and first connecting walls 322a connecting the inner wall 318a and the outer wall 314a within the first and second cylinder portions 186a, 190a. The series of walls 310a further includes a second connecting wall 434 that extends between the inner wall 318a and the outer wall 314a along a vertical centerline D within middle portion 194a. The series of walls 310a and the bottom surface 306a form a first stage intake channel 438, a first stage exhaust channel 442, a second stage intake channel 446, a second stage exhaust channel 450, and a muffler channel 334a. Similar to the valve plate 50a, the first stage intake channel 438 is defined by the outer wall 314a, the inner wall 318a, one of the first connecting walls 322a, and the second connecting wall 434 within the first cylinder portion 186a. The first stage exhaust channel 442 and the second stage intake channel 446 are continuous with one another and are defined within the first and second cylinder portions 186a, 190a, and the middle portion 194a by the outer wall 314a, the inner wall 318a, and the first connecting grooves 250a so as to form an intermediate channel. The second stage exhaust channel 450a is formed within the second cylinder portion 250a by the outer wall 314a, the inner wall 318a, one of the first connecting walls 322a, and the second connecting wall 434.

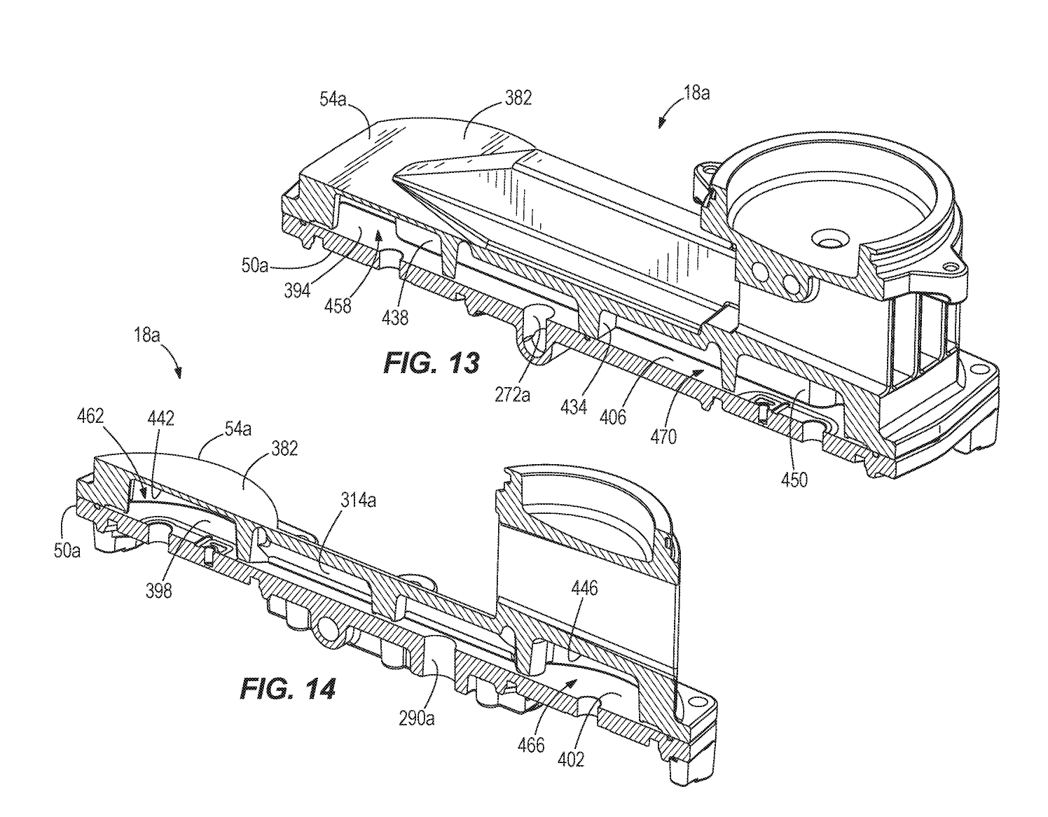

The series of walls 310a correspond to the grooves 238a, such that when the valve plate 50a and the head cover 54a are coupled together the first stage intake section 394, the first stage exhaust section 398, the second stage intake section 402, the second stage exhaust section 406, and the muffler section 262 align with the first stage intake channel 438, the first stage exhaust channel 442, the second stage intake channel 446, the second stage exhaust channel 450, and the muffler channel 334, respectively, so as to form a first stage intake chamber 458, a first stage exhaust chamber 462, a second stage intake chamber 466, a second stage exhaust chamber 470, and the muffler chamber 350a, respectively, as shown in FIGS. 13-14. The first stage intake chamber 458 extends between and encloses the intake opening 272a and the first bore inlet aperture 414. The second stage exhaust chamber 470 encloses the second bore outlet aperture 426. The first stage exhaust chamber 462 and the second stage intake chamber 466 are continuous so as to form an intermediate chamber that extends between and encloses the first bore outlet aperture 418 and the second bore inlet aperture 422. In alternative embodiments, the connecting walls 322a may extend along the horizontal centerline B and meet to form a single wall that extends longitudinally across the head cover 54a, in lieu of a muffler chamber 350a (i.e., similar to center wall 482 of FIGS. 15-20).

With continued reference to FIG. 12, the muffler chamber 350a is positioned generally between the intermediate chamber, the first stage intake chamber 458, and the second stage exhaust chamber 470 such that the intermediate chamber, the first stage intake chamber 458, and the second stage exhaust chamber 470 surround the muffler chamber 350a around a perimeter of the muffler chamber 350a defined by the inner wall 318a. Accordingly, the first portion 319a of the inner wall 318a partially defines the first stage intake chamber 458 and partially defines the second stage exhaust chamber 470, and the second portion 320a of the inner wall 318a partially defines the intermediate chamber, thereby separating the exhaust chamber 346 and the intake chamber 342 by a width of the muffler chamber 350a. In this configuration, the muffler chamber 350a provides insulation between the first stage intake chamber 458, the intermediate chamber, and the second stage exhaust chamber 470.

With continued reference to FIG. 12, the bottom surface 306a of the head cover 54a defines a single exhaust outlet passage 358a in the second cylinder portion 190a that extends from the second stage exhaust chamber 470 to the oxygenator manifold 226a. The bottom surface 306a also defines a single muffler inlet passage 370a extending from the oxygenator manifold 226a of the second cylinder portion 190a to the muffler chamber 350a.

In operation, air is drawn into the first stage intake chamber 470 through the intake port 270a from the surrounding environment during a downstroke of the piston 122a of the first cylinder 30a. The air is then drawn into the bore 98a of the first cylinder 30a through the first bore inlet aperture 414. The flapper valve corresponding to the first bore inlet aperture 414 allows air to enter the bore of the first cylinder 30a, but prevents air from reentering the first stage intake chamber 470. The air is then compressed to a first pressure by the piston 122a of the first cylinder 30a, forced out the first bore outlet aperture 418 into the intermediate chamber (i.e., first stage exhaust chamber 462 and the second stage intake chamber 466). The flapper valve corresponding to the first bore outlet aperture 418 allows air to exit the bore 98a of the first cylinder 30a into the intermediate chamber, but prevents air from reentering the bore 98a of the first cylinder 30a. The compressed air enters the bore 98a of the second cylinder 34a through the second bore inlet aperture 422. The flapper valve corresponding to the second bore inlet aperture 422 allows air to enter the bore 98a of the second cylinder 34a, but prevents air from reentering the intermediate chamber. The air is then compressed to a second pressure higher than the first pressure by the piston 122a of the second cylinder 34a and forced out the second bore outlet aperture 426 into the second stage exhaust chamber 470. The flapper valve corresponding to the second bore outlet aperture 426 allows air to leave the bore 98a of the second cylinder 34a into the second stage exhaust chamber 470, but prevents air from reentering the bore 98a of the second cylinder 34a. The air flows through the exhaust chamber outlet passage 358a to the oxygenator manifold 226a of the second cylinder portion 190a of the head cover 54a. When the solenoid valve is in the first position the compressed air flows through the sieve bed passage 362a to the sieve bed recess 366, where pressure swing absorption separates nitrogen and oxygen. When the solenoid valve is in the second position the purged nitrogen flows through the muffler inlet passage 370a into the muffler chamber 350a, optionally through sound dampening medium or another medium previously described, and out the exhaust port 298a in the center of the muffler section 262a of the valve plate 50a.

FIGS. 15-20 illustrate a head assembly 18b in accordance with a multi-stage, series flow embodiment that may be used in place of the head assembly 18 on the compressor 10 of FIGS. 1-9. Thus, the housing assembly 14 will not be described again in detail, and only differences in the structure and manner of operation of the compressor 10 when using the head assembly 18b of FIGS. 15-20 will be described below. Like components and features to the head assembly 18 of FIGS. 1-9 are identified with like reference numerals plus the letter “b” and will not be described again in detail.

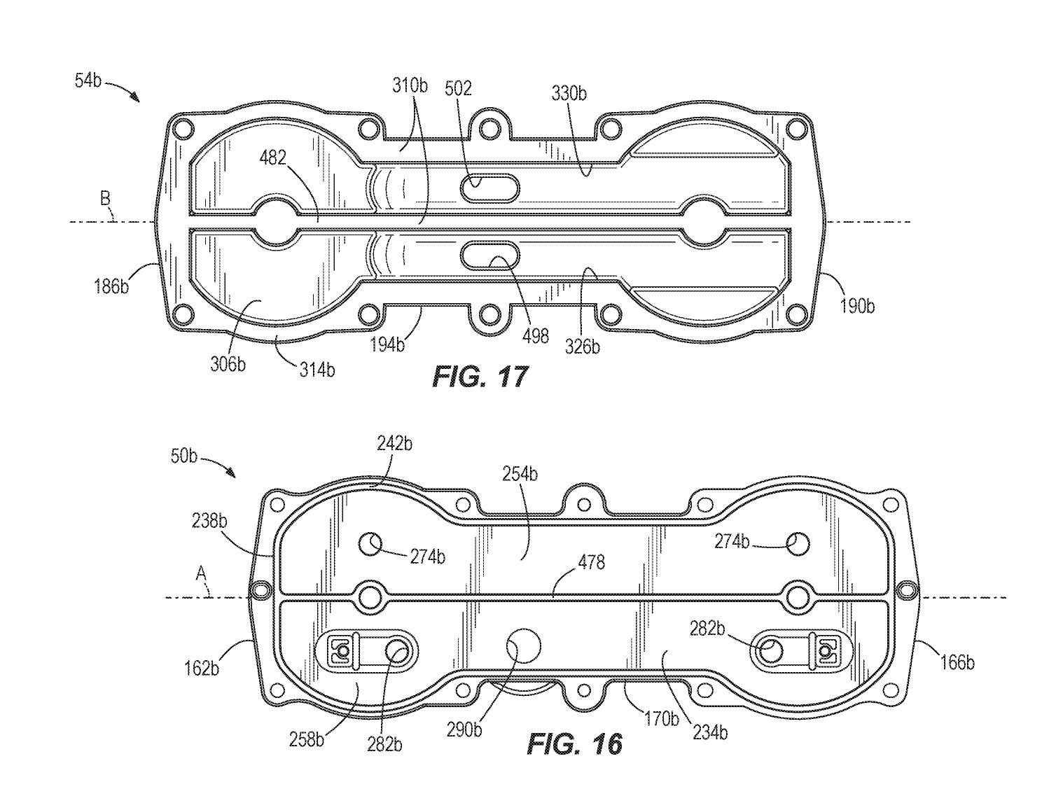

With reference to FIGS. 15-16, the grooves 238b in the top surface 234b of the valve plate 50b comprise an outer groove 242b extending around the perimeter of the valve plate 50b, and a single center groove 478 extending along a horizontal centerline A of the valve plate 50b bisecting the first cylinder portion 162b, the middle portion 170b, and the second cylinder portion 166b of the top surface 234b to define an intake section 254b and an exhaust section 258b. Accordingly, the intake section 254b and the exhaust section 258b are on opposite sides of the center groove 478.

The valve plate 50b includes a bore inlet aperture 274b defined in and extending through each of the first and second cylinder portions 162b, 166b corresponding to each of the cylinders 30, 34 within the intake section 254b. Each of the bore inlet apertures 274b has a corresponding bore inlet flapper valve (not shown) to allow intake air to enter the cylinders 98b from the intake section 254b, but not vice versa. The valve plate 50b further includes a bore outlet aperture 282b defined in and extending through each of the first and second cylinder portions 162b, 166b corresponding to each of the cylinders 30b, 34b within the exhaust section 258b. Each of the bore outlet apertures 282b has a corresponding bore outlet flapper valve (not shown) to allow exhaust air to exit the cylinder bores 98b, but not vice versa.

With reference to FIGS. 17-20, the walls 310b of the head cover 54b correspond to the grooves 238b of the valve plate 50b and include an outer wall 314b extending around the perimeter of the head cover 54b, and a center wall 482 within the perimeter of the outer wall 314b extending along the horizontal centerline B of the head cover 54b bisecting the first cylinder portion 186b, the middle portion 194b, and the second cylinder portion 194b to form an intake channel 326b, and an exhaust channel 330b. Accordingly, the intake channel 326b and the exhaust channel 330b are on opposite sides of the center wall 482.

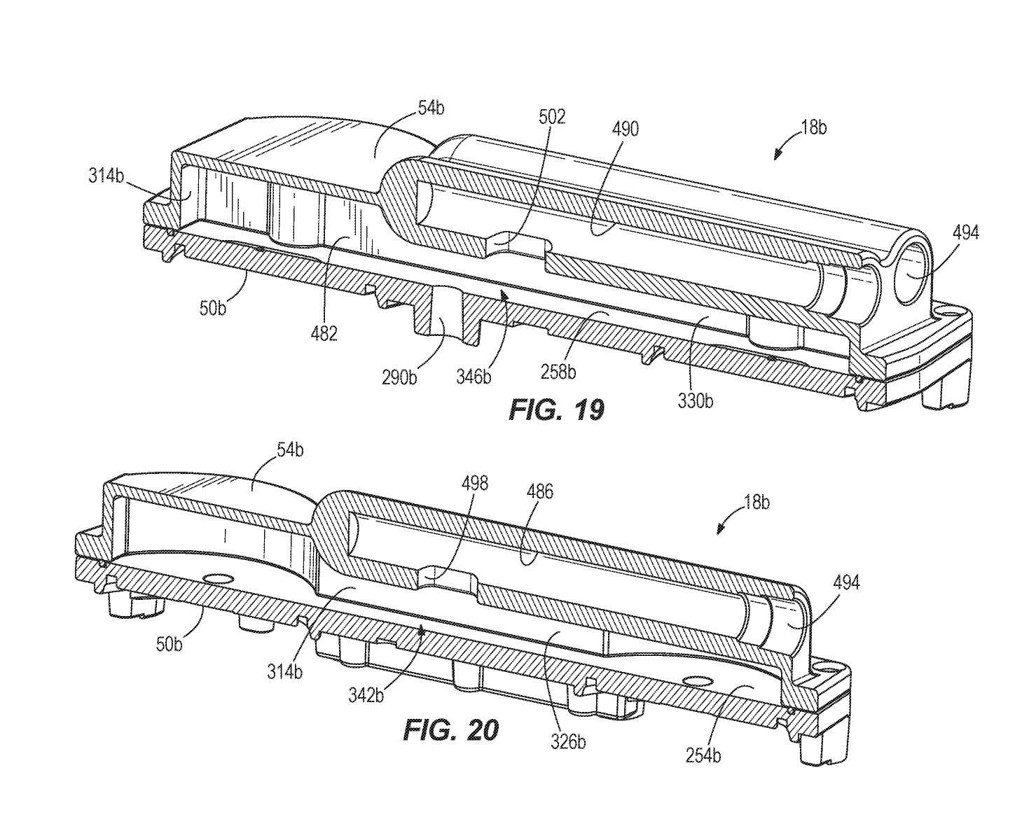

The series of walls 310b correspond to the grooves 328b, such that when the valve plates 50b and the head cover 54b are coupled together the intake section 254b and the exhaust section 258b align with the intake channel 326b and the exhaust channel 330b, so as to form an intake chamber 342b and an exhaust chamber 346b, respectively, as shown in FIGS. 19-20. The intake chamber 342b extends between and encloses the bore inlet apertures 274b. The exhaust chamber 346b extends between and encloses the bore outlet apertures 282b.

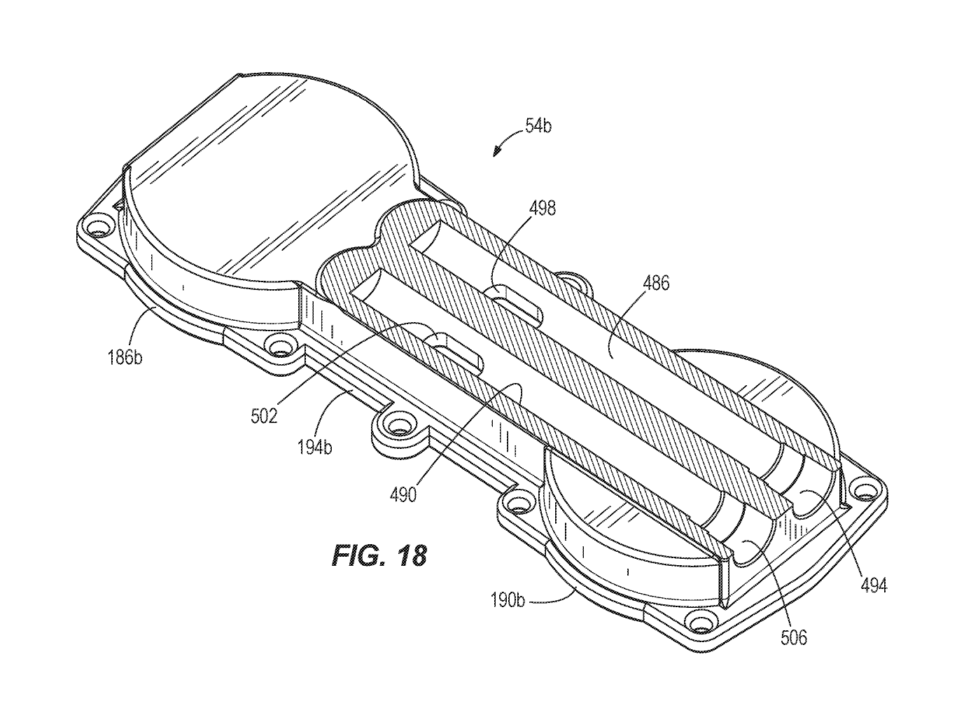

With continued reference to FIGS. 17-20, the head cover 54b defines an intake passage 486 and an exhaust passage 490. The intake passage 486 extends from an intake passage inlet 494 to an intake passage outlet 498 defined in the inner bottom surface 306b within the intake channel 326b to communicate the environment with the intake chamber 342b (FIGS. 18 and 20). The exhaust passage 490 extends from an exhaust passage inlet 502 to an exhaust passage outlet 506 to communicate the exhaust chamber 346b with the environment (FIGS. 18-19). The exhaust passage 490 or the intake passage 486 may be connected to a system or reservoir. The exhaust passage 490 and the intake passage 486 each define a volume that provides sound dampening of gas passing through the passages 486, 490. Alternatively, sound dampening medium may at least partially line or be positioned within one or both of the exhaust passage 490 and the intake passage 486. In some embodiments, one or both of the passages 486, 490 may include a plurality of baffles extending from any of the walls defining the passages 486, 490 of the head cover 54. Accordingly, one or both of the exhaust passage 490 and the intake passage 486 may further be used as a muffler chamber that is integrally formed with the head cover 54b. In some embodiments, a filter medium may be positioned within one or both of the passages 486, 490.

In operation, air is drawn into the intake passage 486 through the intake passage inlet 494 from the surrounding environment and then enters into the intake chamber 342b through the intake passage outlet 498 during a downstroke of the piston 122b of the first and second cylinders 30b, 34b. Optionally, the air passes through sound dampening medium or another medium previously described, within the intake passage 486. The air is then alternatively drawn into bore 98b of each of the first and second cylinders 30b, 34b through the corresponding bore inlet aperture 274b depending on the direction of travel of the respective piston 122b. The inlet flapper valves permit air to enter the bores 98b from the intake chamber 342b, but prevent air from entering the intake chamber 342b from the bores 98b. The air is thereafter compressed by the upstroke of the piston 122b within the bore 98b and forced out the respective bore outlet aperture 282b through the outlet flapper valve at an increased pressure. The outlet flapper valve prevents the compressed air from reentering the bore 98b. The compressed air leaves the bore outlet aperture 282b of each of the first and second cylinders 30b, 34b and enters the exhaust chamber 346b. The compressed air recombines (the extent of which depends on the rotational speed of the drive shaft 66b) after exiting the bores 98b of each of the cylinders 30b, 34b within the exhaust chamber 346b and flows from the exhaust chamber 346 into the exhaust passage 490 via the exhaust passage inlet 502. The compressed air passes through the exhaust passage 490 before exiting via the exhaust passage outlet 506. Optionally, the air passes through sound dampening medium or another medium previously described, within the exhaust passage 490.

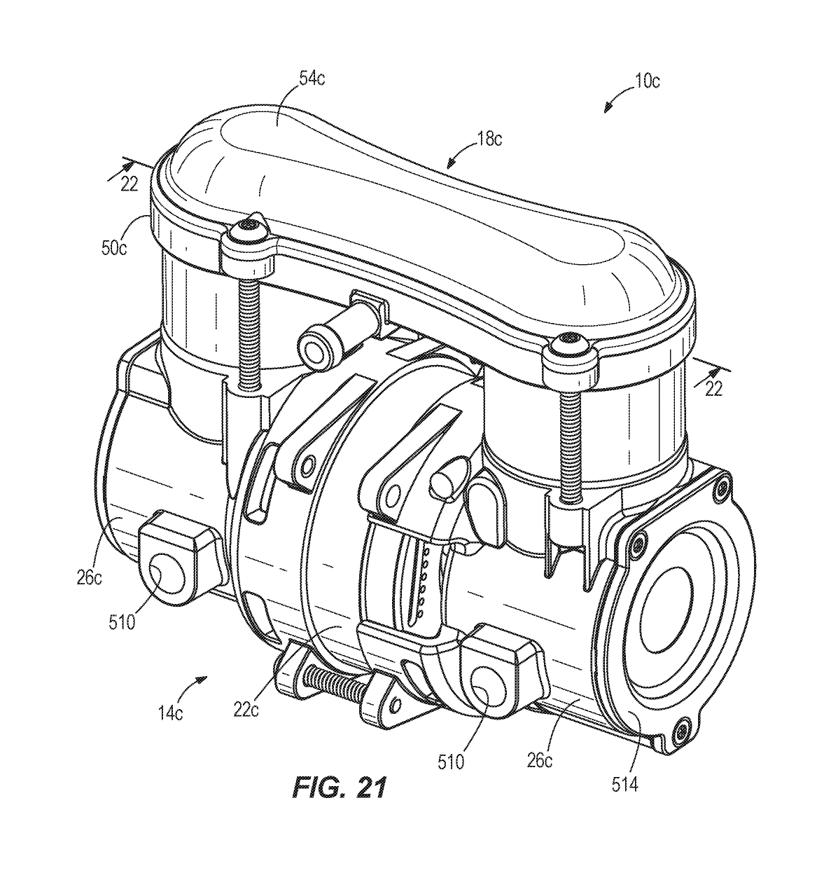

FIGS. 21-25 illustrate a head assembly 18c for a compressor 10c in accordance with a single exhaust chamber embodiment. Like components and features are identified with like reference numerals plus the letter “c” and will not be described again in detail. In particular, the housing assembly 14 is substantially identical to the housing assembly of FIGS. 1-9, with exception of a few features described in detail below.

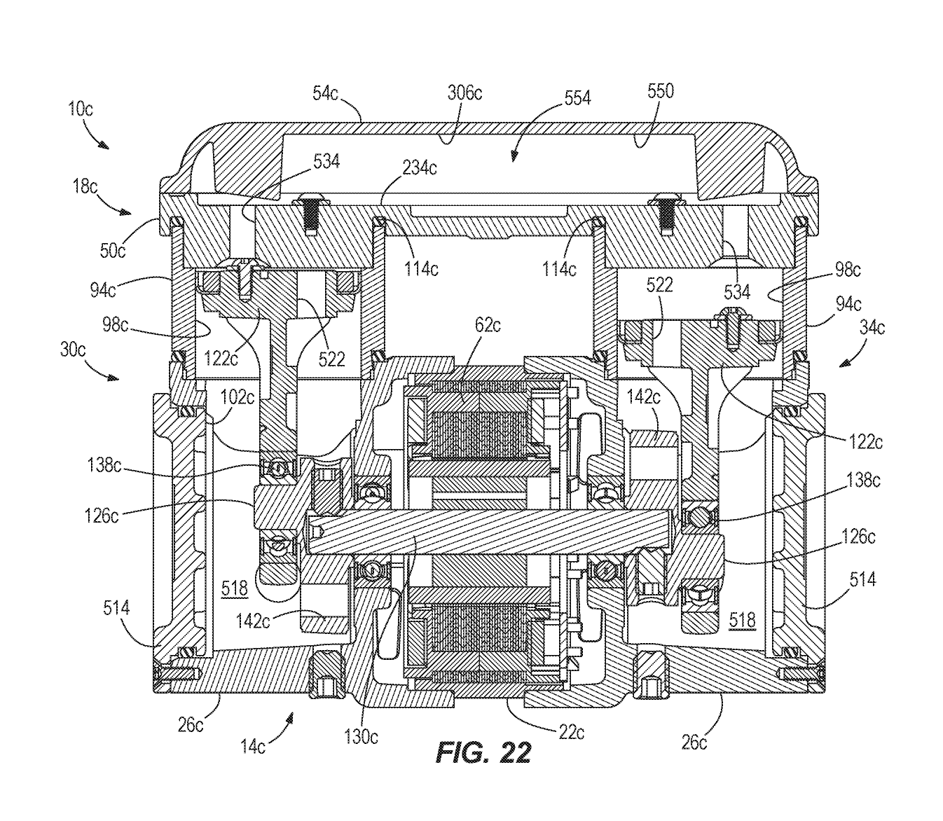

With reference to FIGS. 21-22, the end housings 26c each define an intake port 510. The housing assembly 14c further includes an end cap 514 that is coupled to each of the end housings 26c to form an intake chamber 518 within each of the end housings 26c. Each of the pistons 122c defines a bore inlet aperture 522 with a corresponding flapper valve (not shown) that allows air to enter the bore 98c during the downstroke, but not the upstroke of the piston 122c.

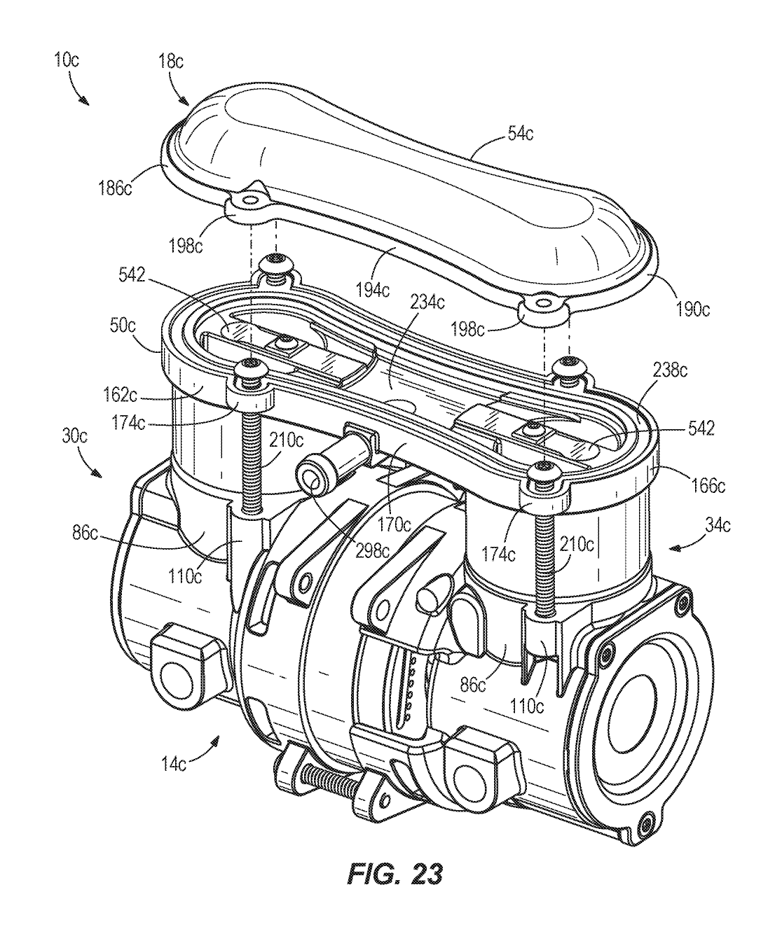

With reference to FIGS. 23-25, the valve plate 50c includes a groove 238c that extends around an outer perimeter of the first and second cylinder portions 162c, 166c and the middle portion 170c. The valve plate 50c has a top surface 234c, and includes projections and corresponding recesses that extend downward into the valve plate 50c and the bores 98c. The groove 238c defines an exhaust section 530 that is continuous between the first and second cylinder portions 162c, 166c and the middle portion 170c of the valve plate 50c. A bore outlet aperture 534 is defined in each of the first and second cylinder portions 162c, 166c so as to extend through the valve plate 50c for fluid communication with each of the bores, each of the bore outlet apertures 534 having a corresponding bore outlet flapper valve 542 (FIG. 23). An exhaust opening 538 in fluid communication with the exhaust port 298c extends from the exhaust section 530 in the middle portion 170c of the valve plate 50c to atmosphere.

The head cover 54c includes an outer wall 314c extending around a perimeter of the first and second cylinder portions 186c, 190c, and the middle portion 194c of the head cover 54c to define an exhaust channel 550. The outer wall 314c of the head cover 54c corresponds to the groove 238c of the valve plate 50c, such that when the valve plate 50c and the head cover 54c are coupled together, the exhaust section 530 and the exhaust channel 550 form an exhaust chamber 554. The exhaust chamber 554 extends between and encloses an exhaust opening 538 of the exhaust port 298c and the bore outlet apertures 534. A gasket (not shown) may be received in the groove 238c and compressed by the outer wall 314c to seal the exhaust chamber 554.

In operation, air is drawn into each of the intake chambers 518 through the intake ports 510 of the end housings 26c from the surrounding environment during the downstroke of each of the pistons 122c. The air is then drawn into the bore 98c of each of the cylinders 30c, 34c through the bore inlet aperture 522 into the piston 122c. The inlet flapper valves allow air into the bore 98c, but prevent air from reentering the intake chamber 510. The air is compressed during the upstroke of the piston 122c within the bore 98c. Compressed air is forced through the bore outlet aperture 534 into the exhaust chamber 554. The outlet flapper valve 542 allows air into the exhaust chamber 554, but prevents air from reentering the bore 98c. Compressed air from both the first and second cylinders 30c, 34c combines within the exhaust chamber 554, which fluidly connects the first and second cylinders 30, 34c. The compressed air from both the first and second cylinders 30, 34c then exits the exhaust chamber 554 through the exhaust port 298c.

Although not shown baffles may be positioned within exhaust chamber 554 so as to provide a circuitous path for compressed air passes to flow from the bore outlet apertures 534 to the exhaust port 298c to provide sound dampening. Baffles may extend down from the head cover 54c or up from the valve plate 50c between the middle portion 194c and the first cylinder portion 186c, and the middle portion 194c and the second cylinder portion 190c. Alternatively, the exhaust chamber 554 may contain or be lined with a sound dampening medium to provide sound dampening to compressed gas passing through the exhaust chamber 554 from outlet apertures 534 to the exhaust port 298c.

In further alternative embodiments the valve plate and the head cover of the head assembly may have any arrangement to facilitate various flow configurations. In one further embodiment the head assembly may be configured to have a pressure driven pump in the first cylinder and a vacuum driven pump in the second cylinder. That is, the first cylinder portion of the valve plate and head cover has corresponding walls and grooves that come together to form an intake chamber and an exhaust chamber, and the second cylinder portion of the valve plate and the head cover has corresponding walls and grooves that come together to form an intake chamber and an exhaust chamber. In such a configuration, the intake and exhaust chambers of each of the first and second cylinder portions are independent from one another, so that one is a pressure driven pump and one is a vacuum driven pump. Alternatively, the first cylinder portion may form an exhaust chamber only, in which the intake is beneath the piston, and/or the second cylinder portion may form an intake chamber only, in which the exhaust is beneath the piston.

In another embodiment, the head assembly may be configured as a multi-stage compressor, in which intake in the first cylinder is beneath the piston. That is, the valve plate and the head cover have corresponding walls and grooves that cooperate to form a first stage exhaust chamber in the first cylinder portion and a second stage intake chamber in the second cylinder portion that are continuous with one another. The corresponding walls and grooves also form a second stage exhaust chamber in the second cylinder portion.

In yet another embodiment, the head assembly may be configured as a pressure/vacuum multi-stage compressor with an intake in the first cylinder beneath the piston. That is, the valve plate and the head cover define corresponding walls and grooves that cooperate to form a first stage exhaust chamber in the first cylinder portion and a second stage intake chamber in the second cylinder portion that are continuous with one another.

In still yet another embodiment, a compressor having a single cylinder housing with a single bore and corresponding piston is provided. The compressor further includes a head assembly having a valve plate and a head cover. The valve plate has an intake section, an exhaust section, and a muffler section positioned between the intake section and the exhaust section defined by a series of grooves. The intake section has a bore inlet aperture extending through the valve plate and the exhaust section has a bore outlet aperture extending through the valve plate. Each of the bore inlet aperture and the bore outlet aperture has a corresponding flapper valve. The head cover has walls extending from a head cover face that form an intake channel, an exhaust channel, and a muffler channel corresponding to the intake section, exhaust section, and muffler section, such that the head cover can cooperate with the valve plate to form an intake chamber, an exhaust chamber and a muffler chamber. The muffler chamber in this configuration is surrounded around its perimeter by the exhaust chamber and the intake chamber. The muffler chamber may contain or be lined with insulation medium or sound dampening medium. The head cover defines an intake port that extends into the intake chamber, and an exhaust port that extends out the muffler chamber. The head cover further defines a passage extending from the exhaust chamber to the muffler chamber. In operation, air is drawn through the intake port into the intake chamber before entering the bore through the bore inlet aperture. The air is compressed before being forced out the bore outlet aperture into the exhaust chamber. The air then flows through the passage into the muffler chamber provided before exiting through the exhaust port. The head cover may include an oxygen concentrator such that purged nitrogen travels through the muffler chamber.

Although the head assemblies of the illustrated embodiments are two-cylinder compressors, in alternate embodiments the head assemblies may include any number of cylinder portions for corresponding compressors having any number of cylinders. In addition, one of ordinary skill in the art would recognize that the disclosure also equally applies to pumps, and other similar devices that include head assemblies.

While the above describes example embodiments of the present disclosure, these descriptions should not be viewed in a limiting sense. Rather, several variations and modifications can be made without departing from the scope of the present disclosure.

Various features and advantages are set forth in the following claims.

What is claimed is:

1. A multi-cylinder compressor or pump, comprising:
a first cylinder housing including a first bore and a second cylinder housing including a second bore;
a motor having a drive shaft;
a first piston coupled to the drive shaft and received in the first bore and a second piston coupled to the drive shaft and received in the second bore;
a valve plate including a first cylinder portion and a second cylinder portion, the valve plate further including a valve plate face with a first aperture extending through the first cylinder portion and a second aperture extending through the second cylinder portion, wherein the first cylinder portion of the valve plate is coupled to the first cylinder housing and the second cylinder portion of the valve plate is coupled to the second cylinder housing such that the first aperture is in fluid communication with the first bore and the second aperture is in fluid communication with the second bore;
a head cover including a head cover face, the head cover being operatively coupled to the valve plate;
a first chamber formed by the valve plate cooperating with the head cover, the first chamber extending between and enclosing the first and second apertures; and
a second chamber formed by the valve plate cooperating with the head cover, the second chamber being in fluid communication with the first chamber.

2. The multi-cylinder compressor or pump of claim 1, wherein a wall of the second chamber at least partially defines the first chamber.

3. The multi-cylinder compressor or pump of claim 1, wherein the valve plate face further includes a third aperture extending through the first cylinder portion in fluid communication with the first bore and a fourth aperture extending through the second cylinder portion in fluid communication with the second bore, and further comprising a third chamber formed by the valve plate cooperating with the head cover, the third chamber extending between and enclosing the third and fourth apertures.

4. The multi-cylinder compressor or pump of claim 3, wherein the second chamber is located between the first chamber and the third chamber such that a first wall of the second chamber at least partially defines the first chamber and a second wall of the second chamber at least partially defines the third chamber.

5. The multi-cylinder compressor or pump of claim 4, wherein the third chamber is at least partially lined with a sound dampening medium.

6. The multi-cylinder compressor or pump of claim 4, wherein the third chamber is at least partially lined with an insulation medium.

7. The multi-cylinder compressor or pump of claim 1, further comprising a third chamber and a fourth chamber each formed by the valve plate cooperating with the head cover, wherein the valve plate face further includes a third aperture extending through the first cylinder portion and a fourth aperture extending through the second cylinder portion, and wherein the third aperture is positioned within and enclosed by the third chamber and the fourth aperture is positioned within and enclosed by the fourth chamber.

8. The multi-cylinder compressor or pump of claim 1, wherein one of the valve plate and the head cover defines an opening enclosed by the second chamber, and wherein the opening is in fluid communication with atmosphere.

9. The multi-cylinder compressor or pump of claim 1, wherein at least one wall extends from one of the valve plate face and the head cover face to form a channel, wherein the channel cooperates with the other of the valve plate face and the head cover face to form the second chamber when the head cover and valve plate are coupled together.

10. The multi-cylinder compressor or pump of claim 1, wherein the second chamber defines a bend portion therein, wherein the bend portion is between approximately 75 and 105 degrees.

11. The multi-cylinder compressor or pump of claim 1, wherein the head cover includes a sieve bed seat for supporting a gas separation device, and wherein the head cover further defines a first passage fluidly communicating the gas separation device with the first chamber, and a second passage fluidly communicating the gas separation device with the third chamber.

12. The multi-cylinder compressor or pump of claim 11, wherein the gas separation device is an oxygen concentrator.

13. A head assembly for a multi-cylinder compressor or pump having first and second cylinders, the head assembly comprising:
a valve plate including a first cylinder portion and a second cylinder portion, the valve plate further including a valve plate face with a first aperture extending through the first cylinder portion and a second aperture extending through the second cylinder portion;
a head cover including a head cover face, the head cover being operatively couplable to the valve plate;
a first chamber formed by the valve plate cooperating with the head cover, the first chamber extending between and enclosing the first and second apertures;
a second chamber formed by the valve plate cooperating with the head cover, the second chamber being in fluid communication with the first chamber.

14. The head assembly of claim 13, wherein a wall of the second chamber at least partially defines the first chamber.

15. The head assembly of claim 13, wherein the valve plate face further includes a third aperture extending through the first cylinder portion and a fourth aperture extending through the second cylinder portion, and further comprising a third chamber formed by the valve plate cooperating with the head cover, the third chamber extending between and enclosing the third and fourth apertures.

16. The head assembly of claim 15, wherein the second chamber is located between the first chamber and the third chamber such that a first wall of the second chamber at least partially defines the first chamber and a second wall of the second chamber at least partially defines the third chamber.

17. The head assembly of claim 13, further comprising a third chamber and a fourth chamber each formed by the valve plate cooperating with the head cover, and wherein the valve plate face further includes a third aperture extending through the first cylinder portion and a fourth aperture extending through the second cylinder portion, and wherein the third aperture is positioned within and enclosed by the third chamber and the fourth aperture is positioned within and enclosed by the fourth chamber.

18. The multi-cylinder compressor or pump of claim 17, wherein the second chamber is located between the first chamber, the third chamber, and the fourth chamber such that a first wall of the second chamber at least partially defines the first chamber and a second wall of the second chamber at least partially defines the third chamber and the fourth chamber.

19. The head assembly of claim 13, wherein at least one wall extends from one of the valve plate face of the valve plate and the head cover face of the head cover to form a channel, wherein the channel cooperates with the other of the valve plate face and the head cover face to form the second chamber when the head cover and the valve plate are coupled together.

20. The head assembly of claim 13, wherein the second chamber defines a bend portion therein, wherein the bend portion is between approximately 75 and 105 degrees.

21. A multi-cylinder compressor or pump, comprising:
a first cylinder housing defining a first bore and a second cylinder housing defining a second bore; and a head assembly including a valve plate and a head cover, wherein the valve plate cooperates with the head cover to form a first chamber, a second chamber, and a third chamber, and wherein the first chamber along with the second chamber surround a perimeter of the third chamber.

22. A multi-cylinder compressor or pump, comprising:
a first cylinder housing including a first bore and a second cylinder housing including a second bore;
a motor having a drive shaft;
a first piston coupled to the drive shaft and received in the first bore and a second piston coupled to the drive shaft and received in the second bore;
a valve plate including a first cylinder portion and a second cylinder portion, the valve plate further including a valve plate face with a first aperture extending through the first cylinder portion and a second aperture extending through the second cylinder portion, wherein the first cylinder portion of the valve plate is coupled to the first cylinder housing and the second cylinder portion of the valve plate is coupled to the second cylinder housing such that the first aperture is in fluid communication with the first bore and the second aperture is in fluid communication with the second bore;
a head cover including a head cover face, the head cover being operatively coupled to the valve plate;
a first chamber formed by the valve plate cooperating with the head cover, the first chamber extending between and enclosing the first and second apertures; and
a second chamber integrally formed as one piece with one of the valve plate and the head cover and in communication with the first chamber.
